(19) United States
(12) Patent Application Publication
(10) Pub. No.: US 2023/0399213 A1
(43) Pub. Date: Dec. 14, 2023

(54) DEVICE AND METHOD FOR CHECKING A CONTOUR OF A LOAD ACCOMMODATED ON AN INDUSTRIAL TRUCK

(71) Applicant: Jungheinrich Aktiengesellschaft, Hamburg (DE)

(72) Inventors: Paul Hohmann, Moosburg (DE); Dennis Greguhn, Marzling (DE); Johannes Sedlmeier, Hagsdorf (DE)

(21) Appl. No.: 18/328,469

(22) Filed: Jun. 2, 2023

(30) Foreign Application Priority Data
Jun. 2, 2022 (EP) 22176970.6

(51) Int. Cl. B66F 9/075; B66F 9/06; G01B 11/25

(52) U.S. Cl. CPC B66F 9/0755; B66F 9/063; G01B 11/25

(57) ABSTRACT

A device for checking a contour of a load received on an industrial truck. The device comprises a subsurface travelable by the industrial truck and two or more sensor units configured for recording two-dimensional data and arranged such that a substantially vertical detection area is spanned. The device comprises a control device configured to one or more of specify or determine the relative position of the industrial truck located on the travelable subsurface with respect to the substantially vertical detection area. The control device comprises at least one evaluation unit configured to evaluate data recorded by the two or more sensor units to determine, based on the relative position, that the area occupied by one or more of the industrial truck or the load carried by the industrial truck in the detection area meets a predetermined condition.

### CROSS REFERENCE TO RELATED APPLICATION

This application claims priority to European Patent Application No. 22176970.6, filed in Germany on Jun. 2, 2022, the entire contents of which are hereby incorporated herein by reference.

### TECHNICAL FIELD

The present invention deals with the topic of monitoring the contour of goods arranged on load carriers, which are conveyed within logistics environments with the aid of industrial trucks and thereby form loads in the sense of the present application.

### BACKGROUND

Due to the fact that the processing of goods in logistics devices of this type is increasingly automated, a check of the contours of the goods on their load carriers, that is to say for example a pallet or the like, is necessary in order to ensure that the goods do not project beyond the load carrier contour during further handling by means of industrial trucks or rack operating devices, or, in other words, the load to be borne by an industrial truck lies in a predetermined target range with regard to its geometric dimensions.

Should such a check be omitted and there, in fact, be a projection of goods over a load carrier contour or, for other reasons, a load does not comply with a predetermined contour, this could lead to damage to the goods or installations in the logistics facility or also to accidents, for example collisions with rack supports or other goods during their storage, wherein it is also possible for goods or goods parts to come to a standstill.

In this context, it is known from the prior art to check the contours of goods on load carriers in relation to the load carriers by means of devices which take over the corresponding load carriers for their inspection. This can be carried out, for example, in a stationary manner before the storage into a shelf within the framework of a transfer to a rack operating device in a station provided for this purpose, as is carried out, for example, in the installation from EP 3 464 124 B1.

It is also known to carry out a check of such contours during transport on a conveyor belt by means of a light grid, as is described, for example, in U.S. Pat. No. 8,564,791, on which conveyor belt the corresponding load carriers are placed before their inspection and then guided on the latter through the light grid.

### SUMMARY

However, the two mentioned procedures from the prior art in each case require a transfer of the load to be inspected to a device provided for the check, i.e., for example, a control station or a conveyor belt in the manner mentioned, which is time-consuming and requires additional working steps when handling the corresponding loads. Thus, there is still potential for improvement in the checking of contours of loads that a corresponding inspection of a contour of a load should be made possible in a manner which does not require any additional handling steps, but can be integrated in an advantageous manner into existing working steps and can thus be carried out in a time-saving manner and with little personnel use.

For this purpose, the present invention proposes a device for controlling a contour of a load which is accommodated on an industrial truck and comprises a substrate which can be driven by the industrial truck and at least two sensor units, wherein the sensor units for recording two-dimensional data are configured and arranged in such a way that a substantially vertical detection area is spanned, wherein the device further comprises a control device, which is configured to predefine and/or determine the relative position of the industrial truck located on the drivable substrate with respect to the detection area, and at least one evaluation unit which is set up to evaluate the data recorded by the sensor units to determine whether the area occupied in the detection area by the industrial truck and/or the load carried by it fulfills a predetermined condition, taking into account the relative position.

Therefore, the device according to the invention provides the possibility of carrying out the checking of a contour of a load, i.e. in particular of goods received on a load carrier such as a pallet, directly during its transport with an industrial truck. In this case, the control device is a stationary device by means of which the industrial truck can pass through or at least move into the drivable substrate and which is consequently not arranged on the vehicle itself and also requires no transfer to a separate station. By using sensor units with the ability to record two-dimensional data in the manner according to the invention, a layer-by-layer check of a respective sectional plane at each time of the checking operation is further carried out and as soon as an injury to the predetermined condition is determined, the contour to be checked can be classified as undesirable or unsuitable.

The particular advantage of this design of a control device is that the verification of the contour can be checked in a very time-saving manner during its transport with an industrial truck, even without the use of a stationary control station or a conveyor belt.

Furthermore, it is to be stated in this context that the specified predetermined condition generally relates to maximum permitted dimensions of the load in the currently considered plane, so that, for example, protection fields can be specified in which the mentioned load cannot protrude. The evaluation of such protected fields can take place, for example, in the sensor units themselves or more complex data processing steps can be undertaken to evaluate data supplied by the sensor units in this regard. In this case, a violation of the predetermined condition or an intervention in a protected field can initiate different processes, for example the corresponding industrial truck can first be put into a safe state and, if necessary, be moved in a predetermined area of the logistics system and/or a manual check of the load can be requested before a further handling thereof is not permissible. Alternatively, it could also be provided that the load is switched off at a corresponding location for a further check.

Further, it should be mentioned at this point that, although the at least two sensor units can be arranged in such a way that a single substantially vertical detection area is simultaneously covered by all sensor units, so that it is in a single plane, on the other hand it is also conceivable that the sensor units can be offset relative to one another by a certain amount in a direction perpendicular to the respective detection areas, that is to say in particular a direction of movement of the industrial truck, on the drivable substrate during a checking operation. In such a case, the relative position of the industrial truck located on the drivable substrate in relation to the detection area would then be respectively to be considered per sensor unit, while in the case of a detection area lying in a single control plane the named relative position would have to be predetermined or determined only once.

It should also be pointed out at this juncture that the provision or determination of the relative position of the industrial truck located on the drivable substrate relates to the fact that a passage of the industrial truck can either be predetermined by the control device, wherein the industrial truck then has to carry out an exact movement sequence on the drivable substrate with a high position precision, or the industrial truck with a lower precision moves the drivable underlying surface in the control device and the precise position thereof is determined by the control device, for example on the basis of sensor data or position data delivered by the vehicle itself.

With regard to the configuration of the sensor units, different approaches can in principle be tracked as long as two-dimensional data for determining a contour can be recorded with sufficient accuracy and further processed accordingly. Therefore, acoustic sensors and, for example, 3D cameras could be used for this purpose, in a preferred embodiment of the present invention, however, the sensor units can be designed in particular as laser scanners, wherein such laser scanners with the mentioned properties and suitability including sufficient precision for a device according to the invention can be easily integrated on the market and easily integrated into such a device.

In particular in embodiments in which the device according to the invention comprises exactly two sensor units, these can be oriented relative to one another in such a way that the detection area is designed as a rectangle, in that the sensor units are located in two mutually opposite corners thereof. In such a configuration, one of the two sensor units would check the contour of the upper side and a vertical side of the load, while the other sensor unit would control the opposite vertical side and the underside of the load. Accordingly, there is a further advantage of the present invention in such embodiments that, in contrast to contour control devices from the prior art, in which load carriers stand on a substrate, for example a conveyor belt, an area underneath the load carrier can also be detected when the load carrier is transported through the detection area by means of a load handling means (for example fork prongs) of the industrial truck in the raised state. In this case, moreover, in the case mentioned above of a relative offset of the sensor units with respect to the planes of their detection areas, the formation thereof can be understood as a rectangle in the sense of a projection of the individual detection areas perpendicular to its extension plane.

Furthermore, the named arrangement in two mutually opposite corners of a rectangle can comprise an arrangement of one of the two sensor units in, for example, approximately 2 m height and the other sensor unit just above the drivable substrate, on the basis of conventional dimensions of industrial trucks and loads carried by them. In this way, a rectangle is formed as a detection area, in which a contour check of all loads usually carried by industrial trucks should be possible.

Furthermore, in the present invention, the at least one evaluation unit or at least one of the sensor units can be configured to carry out a segmentation of the detection area in the vertical direction in order to carry out a division of the load received by the industrial truck into one of at least two value ranges with respect to its height. In this way, loads can be distinguished with regard to their height and, for example, can be divided as to whether they exceed or fall below a predetermined first height or whether they fall into one of three predetermined height ranges. As a result of this classification of the loads into different heights, different storage places can be assigned to them in a logistics facility, for example, whereby a further saving of handling time of the individual loads by the device according to the invention can be achieved.

Although, as already mentioned above, an evaluation of the data recorded by the sensor units with respect to the predetermined conditions can also be provided directly in the sensor units themselves, in particular in the case of a simple check of protective fields, which corresponds to an integration of evaluation devices in the sensor units, in another embodiment the control device and the evaluation device can be formed by a common data processing unit which receives sensor data recorded according to the at least two sensor units in order to further process the latter.

In addition, the device according to the invention can comprise a further sensor unit which is designed to detect a speed of the industrial truck traveling on the substrate and which is operatively coupled to the control device and/or the evaluation device, for example in order to always have precise information about the current position thereof according to the direction of movement of the industrial truck, which can contribute to an improved check of the front and rear vertical side of the load.

Furthermore, the present invention relates to a system for controlling a load accommodated on an industrial truck, comprising a control device of the type just described and at least one industrial truck which is designed to carry a load on a load-bearing means, preferably in a height-adjustable manner.

Although the present invention can of course be implemented with any type of industrial truck, that is to say for example also a manually or semi-automatically operated industrial truck, the use of autonomously Guided industrial trucks (also referred to as AGV—Automatic Guided Vehicles, autonomous Mobile Robots or, in German, FTF—Fahrerlose Transportfahrzeuge (Driverless Transport Vehicles)) can be considered. Such autonomously guided industrial trucks receive instructions for their movement and for handling loads from one control center and then carry out these movements and handling tasks in an autonomous manner in a logistics environment. In this case, by using an automated driving operation during the passage through the detection area, a higher precision and positional value can be achieved than in the case of a manual passage, whereby in turn the precision of the control of the contour can be increased. This automated driving operation can be achieved in particular by the use of automatically guided vehicles or AGVs, or also by an assistance system which controls these in other types of industrial trucks in an automated manner at least in the area of the monitoring.

In this case, it is understood that the system according to the invention can be suitable for comprising an entire fleet of such industrial trucks which, in each case at different points in time, travel the drivable substrate of the control device in an intended manner so that the load carried by them can be controlled in terms of its contour. In this case, it is expedient to arrange the control device of the system in the event of an access to a storage area of a logistics facility, for example after the corresponding industrial trucks have been loaded, but before they move into the storage area, in order to be able to ensure that the loads to be handled meet the predetermined conditions with regard to their contours and no accidents due to irregular or defective loads can occur in terms of their contours.

In this case, in a system according to the invention, the control device and the industrial truck can comprise respective communication units in order to enable communication between the two, for example in order that the industrial truck can inform the control device about an imminent entry on the drivable substrate or that the control device can instruct the industrial truck to a correction in terms of its route or position on the basis of sensor data. The aforementioned communication by means of the two communication units can be provided directly or indirectly, i.e. the control device and the industrial truck can either communicate directly with one another or the communication can be carried out via an external entity, such as, for example, a control system of the self-propelled vehicles.

Such a control system can also be included in the system according to the invention and can be configured to transmit work instructions to the at least one industrial truck, wherein the control system can be in communication with the at least one industrial truck and optionally also the control device.

Furthermore, the at least one industrial truck can be configured to determine its absolute or relative position by means of a position sensor unit and to transmit it to the control device. The position determined in this way can be used in the process of controlling the contour of the load accommodated on the industrial truck, wherein such position sensor units usually operate either optically via markings provided in the logistics device or for example also inductively via induction elements provided in the drivable substrate.

Finally, the present invention relates to a method for controlling a contour of a load received on an industrial truck in a system of the type just described, comprising passing through the detection area of the control device by the industrial truck on the drivable substrate.

As already mentioned several times above, it is necessary for this purpose to know exactly the current position of the industrial truck or of the load taken relative to the detection area so that the contours can be controlled with the desired precision, wherein either the detection area is driven through with a precisely predetermined position and orientation or a precisely determined position of the vehicle is taken into account in the control.

In this case, the method according to the invention can further comprise a displacement of the load handling means of the industrial truck to a predetermined height of the lifting device, that is to say for example the stroke of a fork carriage of a fork plow, whereby it can be ensured that a predetermined reference zero point can be precisely maintained in the height direction above the drivable substrate.

When carrying out the method according to the invention, on the one hand, the highest possible throughput speed of the industrial truck is desirable, since in this way time can be saved, and on the other hand, the precision of the measurements necessary for the control would suffer when the transit speed is too high. It has thus been shown that the driving through of the detection area by the industrial truck can be carried out in particular at a speed in a range from 50 to 200 mm/s, more preferably at approximately 125 mm/s. Such a speed represents an optimal compromise between an efficient carrying out of the control and the highest possible precision thereof.

Furthermore, the method according to the invention can comprise at least one of the following steps:
determining a position of the load relative to the load handling means;
checking the detection area for a presence of foreign objects before and/or after passing through the industrial truck
temporarily stopping the passage of the detection area through the industrial truck in order to control a front contour and/or a rear contour of the load.

Since the method according to the invention always provides a sectional image of this plane through the definition of the detection area in one plane, it is possible to stop the contour in the front or rear area of the load in the direction of travel through the device immediately before and/or after the entry of the load into the plane of the detection area of the industrial truck, so that it can be ensured at this point that the load does not protrude into a predefined protection area, including in the two directions mentioned. In this case, such an adaptation of the protection area can be made at these points in time, such that the protection area only relates to components of the industrial truck to be expected in the detection area, for example the corresponding load-bearing means, that is to say in particular fork prongs, fork-backs or the like used for this purpose.

In order to increase the precision of this determination, the already mentioned determination of the position of the load relative to the load-bearing means can also be carried out, for example on the basis of sensors arranged on the industrial truck itself, which can determine a wearing position of the load, for example by means of optical measurements or other measuring methods suitable for this purpose.

By checking the detection area for presence of foreign objects before and/or after passing through the industrial truck, accidents can also be avoided on the one hand and, on the other hand, it can be ensured that the checking of the contour of the load on the industrial truck does not provide any false results caused by a malfunction.

Further, since different types of industrial trucks and/or different load carriers associated with the loads can be checked with different geometries in the method according to the invention or in the system according to the invention, an adjustment of the predetermined condition on the basis of the vehicle type of the industrial truck and/or of a load carrier associated with the load can also be provided in order to be able to take into account these different vehicle or charge carrier geometries.

### BRIEF DESCRIPTION OF THE DRAWINGS

Further features and advantages of the present invention will become even clearer from the following description of an embodiment, when said embodiments are considered together with the accompanying drawings. In detail, the drawings show:

FIG. 1 shows schematic views for explaining the principle of a contour check in a device according to the invention;

FIG. 2 shows a schematic front view of a device according to the invention;

FIG. 3 shows schematic isometric views of the device from FIG. 2 during a checking procedure;

FIG. 4 shows schematic views for explaining a front contour check;

FIG. 5 shows a schematic view for explaining a main contour check;

FIG. 6 shows schematic views for explaining a rear contour check; and

FIG. 7 shows a flow chart for explaining a method according to the invention.

### DETAILED DESCRIPTION

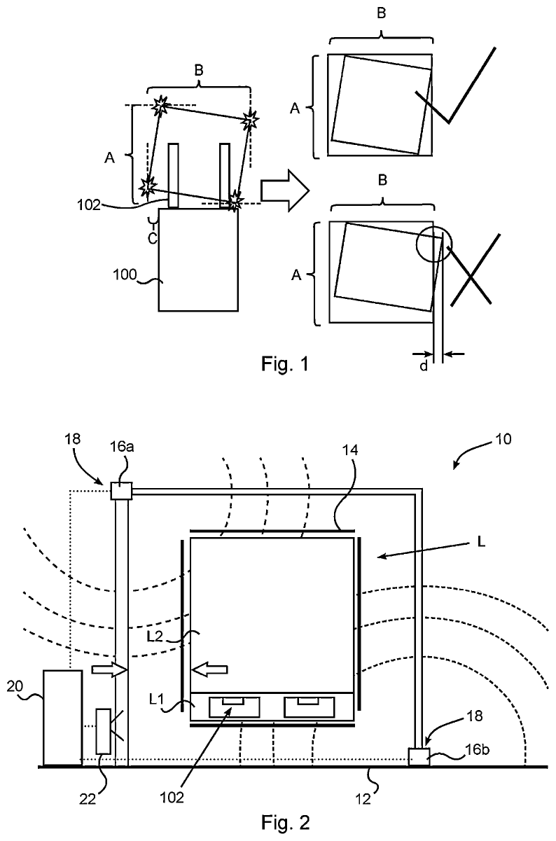

FIG. 1 first shows schematic plan views for explaining the principle of a contour check in a device according to the invention. In this case, an industrial truck 100 bears on its load handling means 102, in this case a fork which is conventional for such purposes, a load L, which is formed in particular by goods received on a load carrier, for example a pallet.

Furthermore, the dimensions A, B and C define an area which cannot be exceeded by the area occupied by the load L, whereby the predetermined condition is defined within the meaning of the present invention. While in the view shown at the top right in FIG. 1, the contour of the load L is completely within the area defined by the dimensions A and B, the contour of the load L exceeds the area of the load L in the view shown at the bottom right, so that in this case the predetermined condition is violated and the contour of the load L is not suitable for further handling of the load L in A corresponding logistics device and corresponding countermeasures must be taken.

In this case, it is understood that a corresponding check of a contour can also take place on an upper side and possibly an underside of the load, so that a three-dimensional check of the load L is carried out overall. For this purpose, the device 10 of FIG. 2 is proposed according to the invention, which is configured to carry out a sequence of two-dimensional checks perpendicular to a direction of movement of the industrial truck 100 in such a way that ultimately a three-dimensional check of the contour of the load L takes place.

As can be seen in FIG. 2, the load L in the configuration shown consists of a pallet L1 received on the load handling means 102 of the industrial truck 100, on which the object L2 is located, so that in particular the orientation or positioning of the object L2 relative to the pallet L1 and the correct reception of the pallet L1 on the load handling means 102 can be checked.

For this purpose, the industrial truck 100 moves a drivable substrate 12, which is to be understood as a part of the device 10 within the meaning of the present invention, in a direction which is substantially perpendicular to a detection area 14 of the device 10. This detection area 14 is defined by two sensor units 16a and 16b in the form of laser scanners known per se and available on the market, which are configured for recording two-dimensional data and are opposite each other in such a way that the detection area 14 has substantially the shape of a rectangle. In particular, taking into account the usual dimensions of industrial trucks 100 and loads L carried by them, the first sensor unit 16a is arranged at a height of approximately 2 m, while the second sensor unit 16b lies only just above the drivable substrate 12.

In the embodiment shown, the two sensor units 16a and 16b are each designed as a laser scanner, as already mentioned, which can generate a two-dimensional point cloud, which represent the outline of objects present in their respective scanning area via the determination of distances. By means of these sensor units 16a, 16b, protective zones or protective fields can be defined into which the load L cannot project according to the principle explained in FIG. 1 without violating the predetermined condition.

In particular, in the embodiment shown in FIG. 2, the first sensor unit 16a thus controls the upper and the left side of the load, while the second sensor unit 16b controls the right and the lower side of the load. Accordingly, in the embodiment shown, the two sensor units 16a, 16b each also act directly as an evaluation unit 18, since they can immediately output a corresponding warning or the like in the event of injury to a respective protective field, and thus the checking of the predetermined condition directly takes place at the sensor units 16a, 16b. In the embodiment shown here, the control device 20 also shown in FIG. 2 therefore only serves to specify or determine a relative position of the industrial truck 100 with respect to the detection area 14, for which purpose a position sensor unit 22 is provided, which supplies corresponding data for localizing the industrial truck 100 and is operatively coupled to the control device 20. By means of this localization, it is possible to adapt the protective fields of the sensor units 16a, 16b, wherein for this purpose data connections are likewise provided between the control device 20 and the sensor units 16a, 16b.

It should be noted at this juncture that, in alternative embodiments, it can also be provided, for example, that the industrial truck 100 itself supplies data to the control device, which represents its own position in the surroundings or relative to the detection area 14, and/or that an integration of the control device 20 and the evaluation device 18 is undertaken, so that the corresponding sensor units 16a, 16b initially only supply raw data in the form of point clouds, which are then also examined for the predetermined condition in the control device 20, which accordingly also takes over the task of the evaluation unit 18. Further, a coupling to or an integration with a control system can also be provided, which in turn is connected to the industrial truck 100 and/or the control unit 20 in order to coordinate the respective operation of the aforementioned devices, so that the industrial truck 100 follows a predetermined path and is located at predetermined points in time in predetermined positions relative to the control device 10, and thus the setting of the protective fields can take place in accordance with the current position of the industrial truck 100 or the load L received by the industrial truck 100.

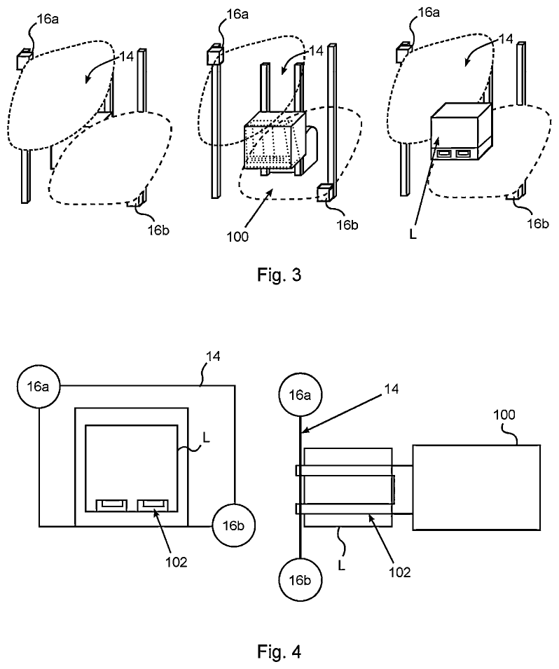

A passage of the industrial truck 100 through the device 10 is now explained with reference to FIG. 3, wherein the load L is not yet present in the detection area in the left-hand representation, is present in the central representation in the detection area 14 and has already left the detection area 14 in the right-hand representation.

The three constellations shown in FIG. 3 are now explained in front view and partially in plan view on the basis of the further FIGS. 4 to 6, wherein in FIG. 4 the load L is initially not yet entered into the detection area 14, which can be seen in the plan view shown on the right in FIG. 4 as a line projection of the corresponding plane. In this case, the front contour of the load L can be checked by corresponding detection by the two sensor units 16a, 16b in this state with sufficiently precise knowledge of the position of the industrial truck 100 with respect to the device 10 and in particular of the detection area 14 and the position of the pallet L1 on the load handling means 102, which can each be determined, for example, by suitable optical sensors. For this purpose, for example at this point in time a protective field of the sensor units 16a, 16b can be adapted in such a way that it only carries out the load handling means 102 itself and each projection of the load L into the detection area 14 leads to a violation of the protective field.

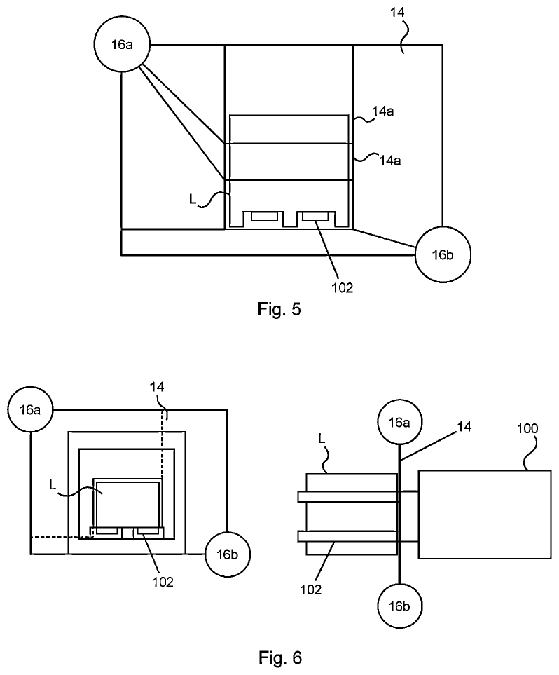

In a similar manner, the rear contour of the load L is checked in the constellation shown in FIG. 6, wherein the protective field can be adapted in such a way that the components of the industrial truck 100 lying in the region of the detection area 14 in FIG. 5 are excluded, that is to say in the embodiment shown, the front of the load handling means 102 or fork back with its known geometry.

In contrast, in FIG. 5, the middle of the states from FIG. 3 is illustrated, in which the load L itself is present in the detection area 14 and its lateral and upper and lower contour can be checked at this point in the direction of movement of the industrial truck 100. In this case, in particular in the height direction, a subdivision of the detection area 14 into two sub-areas 14a and 14b is carried out, wherein for each of the sub-areas 14a and 14b a presence of the load L is checked therein in order to be able to perform a classification of the load L into a height category.

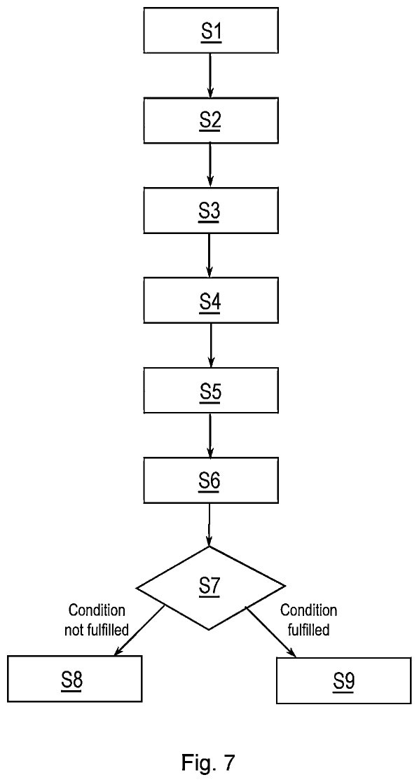

Finally, FIG. 7 shows a flow chart illustrating the sequence of a method according to the invention in a System formed from a device 10 and an industrial truck 100 according to the previously described embodiments. For this purpose, initially in step S1 the industrial truck 100 loaded with a load L transmits to the device 10 by means of respective communication devices of the two information about an imminent passage and via its vehicle type and the position of the load L on its load-bearing means 102. From this information, the device 10 in step S2 determines protection fields of the sensor units 16a, 16b in its control unit 20 which is configured for this purpose, which fields are matched to the geometry of the industrial truck 100 and the known properties of the load L with respect to their relative position.

Alternatively, the communication between the industrial truck 100 and the control device 10 can also be communicated by a superordinate control unit and, in particular, instruct the industrial truck 100 to enter the control device 10, and transmit information about the current position and the operating state (speed, lift height of the load carrier) as well as other properties such as dimensions of the vehicle 100, dimensions and position of the load forks and the fork back on the vehicle, as well as dimensions of the load carrier. Further alternatively, the superordinate control unit can also directly transmit the dimensions of the protected fields to be set, which can be present, for example, in a database of the superordinate control unit. The superordinate control unit can specify a suitable course and a suitable speed to the industrial truck 100 and cause the industrial truck 100 to stop in order to check the front and rear contour of the load L at the correct positions.

The check of a predetermined maximum length of the load L or of the load carrier in the direction of travel results here from a possible injury to the protective fields when the front and rear contours are checked and the respective position of the industrial truck 100 or the distance traveled by the industrial truck 100 between the two stop positions.

In step S3, the industrial truck now starts its passage through the device 10 on the drivable substrate 12, wherein the exact position of the industrial truck 100 is continuously determined by means of suitable sensors and made available to the device 10.

As soon as the position of the industrial truck 100 shown in FIG. 4 has been reached with respect to the detection area 14, the industrial truck stops short in order to carry out the check of the front contour of the load L in step S4 in the manner described above. Subsequently, in step S5, the industrial truck 100 passes through the detection area 14, so that the lateral and upper and lower contours of the load L can be checked in the manner explained with reference to FIG. 5.

As soon as the position shown in FIG. 6 has been reached, the industrial truck 100 stops again and in the manner explained with reference to FIG. 6 the rear contour of the load L is checked in step S6. In this case, an adaptation of the protection fields of the sensor units 16a and 16b takes place between the steps S4, S5 and S6 in order to be able to check the individual portion of the load L in a suitable manner.

Finally, in step S7, an evaluation unit decides whether a violation of one of the protective fields has existed in one of the steps S4 to S6 and thus a predetermined condition has not been met in the sense of the present application. Of course, in the event of injury to a protective field in one of steps S4 to S6, the method could also be terminated immediately, so that step S7 does not necessarily have to take place chronologically after all of the step S4 to S6.

However, if such an injury is the case, i.e. the predetermined condition is not fulfilled continuously, a warning is output and/or the industrial truck is put into a corresponding state so that a manual check of the load or the like can be performed in step S8. If, on the other hand, the contour of the load L completely satisfies the predetermined condition, i.e. has not violated any of the protective fields in steps S4 to S6, then in step S9 the industrial truck moves out of the device 10 and continues its operation in the intended manner.

1. A device for checking a contour of a load received on an industrial truck, comprising:
a subsurface travelable by the industrial truck;
two or more sensor units;
wherein the two or more sensor units are configured for recording two-dimensional data and are arranged such that a substantially vertical detection area is spanned;
a control device configured to determine the relative position of the industrial truck located on the travelable subsurface with respect to the substantially vertical detection area (14); and
at least one evaluation unit configured to evaluate data recorded by the two or more sensor units to determine, based on the relative position, that the area occupied by one or more of the industrial truck or the load carried by the industrial truck in the detection area meets a predetermined condition.

2. The device of claim 1, wherein the two or more sensor units comprise are designed as laser scanners.

3. The device of claim 1, wherein two of the two or more sensor units are oriented relative to one another in such a way that the detection area is configured as a rectangle, wherein the two sensor units are located in two mutually opposite corners of the rectangle.

4. The device of claim 1, wherein the at least one evaluation unit or the two or more sensor units is configured to carry out a segmentation of the detection area in the vertical direction to carry out a division of the load received by the industrial truck into one of at least two value ranges.

5. The device of claim 1, wherein the control device and the evaluation device are formed by a common data processing unit.

6. The device of claim 1, further comprising a further sensor unit configured to detect a speed of the industrial truck traveling on the subsurface and is operatively coupled to one or more of the control device or the evaluation unit.

7. A system for checking a load received on an industrial truck, comprising:
at least one industrial truck configured to carry a load on a load handling means; and
two or more sensor units, wherein the two or more sensor units are configured for recording two-dimensional data and are arranged such that a substantially vertical detection area is spanned;
a control device configured to determine the relative position of the at least one industrial truck located on a travelable subsurface with respect to a substantially vertical detection area;
at least one evaluation unit configured to evaluate data recorded by the two or more sensor units to determine, based on the relative position, that the area occupied by one or more of the industrial truck or the load carried by the industrial truck in the detection area meets a predetermined condition.

8. The system of claim 7, wherein each of the control device and the industrial truck comprises a respective communication unit to enable communication between the control device and the industrial truck.

9. The system of claim 7, further comprising a control system configured to transmit work instructions to the at least one industrial truck, wherein the control system communicates with the at least one industrial truck.

10. The system of claim 7, wherein the at least one industrial truck is configured to determine an absolute position or a relative position of the at least one industrial truck using a position sensor unit and is further configured to transmit the determined absolute position or the determined relative position to the control device.

11. A method for checking a contour of a load received on an industrial truck, comprising:
passing the industrial truck through the detection area of a control device on a drivable substrate, wherein the industrial truck is configured to carry the load on a load handling means;
determine, using the control device, a relative position of the industrial truck located on the drivable substrate with respect to the detection area; and
determine, based on the relative position, that the area occupied by one or more of the industrial truck or the load carried by the industrial truck in the detection area meets a predetermined condition.

12. The method of according to claim 11, further comprising moving the load handling means to a predetermined height.

13. The method of claim 11, wherein the industrial truck travels through the detection area at a speed in a range from 50 to 200 millimeters per second (mm/s).

14. The method of claim 11, further comprising one or more of:
determining a position of the load relative to the load handling means,
checking the detection area for a presence of foreign objects before and/or after passing the industrial truck through the detection area, or
stopping, for a predetermined amount of time, the passage of the industrial truck through the detection area to control one or more of a front contour of the load or a rear contour of the load.

15. The method of claim 11, further comprising adjusting the predetermined condition using one or more of a vehicle type of the industrial truck or a load carrier associated with the load.

16. The method of claim 13, wherein the speed is substantially 125 mm/s.

17. The system of claim 7, wherein the at least one industrial truck is configured to carry the load on the load handling means in a height-displaceable manner.

18. The system of claim 9, wherein the control system further communicates with the control device.
